(19) United States
(12) Patent Application Publication
(10) Pub. No.: US 2011/0291946 A1
(43) Pub. Date: Dec. 1, 2011

(54) TOUCHPAD INTERACTION

(75) Inventors: Jonathan L. Mann, Seattle, WA (US); Richard Alan Ewing, JR., Renton, WA (US); Parker Ralph Kuncl, Seattle, WA (US); Michael Kemery, Seattle, WA (US); Prarthana H. Panchal, Seattle, WA (US); Benoit F. Collette, Seattle, WA (US); David Winkler, Seattle, WA (US)

(73) Assignee: T-MOBILE USA, INC., Bellevue, WA (US)

(21) Appl. No.: 12/788,239

(22) Filed: May 26, 2010

(51) Int. Cl. G06F 3/041; G06F 3/048; G06F 3/01

(52) U.S. Cl. 345/173; 715/702; 715/810

(57) ABSTRACT

Techniques utilizing a rear-facing touch panel are described for implementing user interfaces in a handheld device.

### BACKGROUND

Handheld devices have become more and more prevalent, in forms such as cellular phones, wireless phones, smartphones, music players, video players, netbooks, laptop computers, e-reading devices, tablet computers, cameras, controllers, remote controls, analytic devices, sensors, and many other types of devices.

User interfaces for handheld devices have become increasingly sophisticated, and many user interfaces now include color bitmap displays. Furthermore, many user interfaces utilize touch sensitive color displays that can detect touching by a finger or stylus. There are many varieties of touch sensitive displays, including those using capacitive sensors, resistive sensors, and active digitizers. Some displays are limited to detecting only single touches, while others are capable of sensing multiple simultaneous touches.

Touch sensitive displays are convenient in handheld devices because of the simplicity of their operation to the user. Menu items can be displayed and a user can interact directly with the menu items by touching or tapping them, without the need to position or manipulate an on-screen indicator such as a pointer, arrow, or cursor. Furthermore, the touch capabilities of the display reduce the need for additional hardware input devices such as buttons, knobs, switches, mice, pointing sticks, track pads, joysticks, and other types of input devices.

One disadvantage of touch sensitive user interfaces, however, is that a user's finger can often obstruct the user's view of the display, and repeated touching of the display can result in fingerprints and smudges that obscure the display. Furthermore, it may be awkward in some devices for a user to both hold the device and to provide accurate touch input via the display, especially with one hand. Because of this, many devices are more awkward in operation than would be desirable.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a rear perspective view of a handheld device utilizing a rear touch panel.

FIG. 2 is a rear view of the handheld device of FIG. 1, showing a possible hand and finger placement relative to a rear touch panel.

FIG. 3 is a rear view of the handheld device of FIG. 1, showing another possible hand and finger placement relative to the rear touch panel.

FIG. 4 is a front perspective view of an alternative handheld device utilizing an edge touch panel.

FIG. 5 is a front view of the handheld device of FIG. 1, showing an embodiment of a banded menu structure that can be used in conjunction with the rear touch panel shown in FIGS. 1 and 2.

FIG. 6 is a front perspective view of the handheld device of FIG. 1, showing the relationship between its rear touch panel and the banded menu structure shown in FIG. 5.

FIG. 7 is a close-up of a banded menu structure such as might be implemented in conjunction with a handheld device.

FIG. 8 is a front view of a handheld device such as shown in FIG. 1, illustrating an example of a possible user interaction with the handheld device.

FIGS. 9-15 are close-ups of banded menu configurations illustrating user interface examples.

FIG. 16 is a flowchart showing how a menu structure such as shown in FIG. 7 might be utilized in a handheld device.

FIG. 17 is a block diagram showing relevant components of a handheld device that might be used to support the menus and related components described herein.

### DETAILED DESCRIPTION

### Back Touch Panel

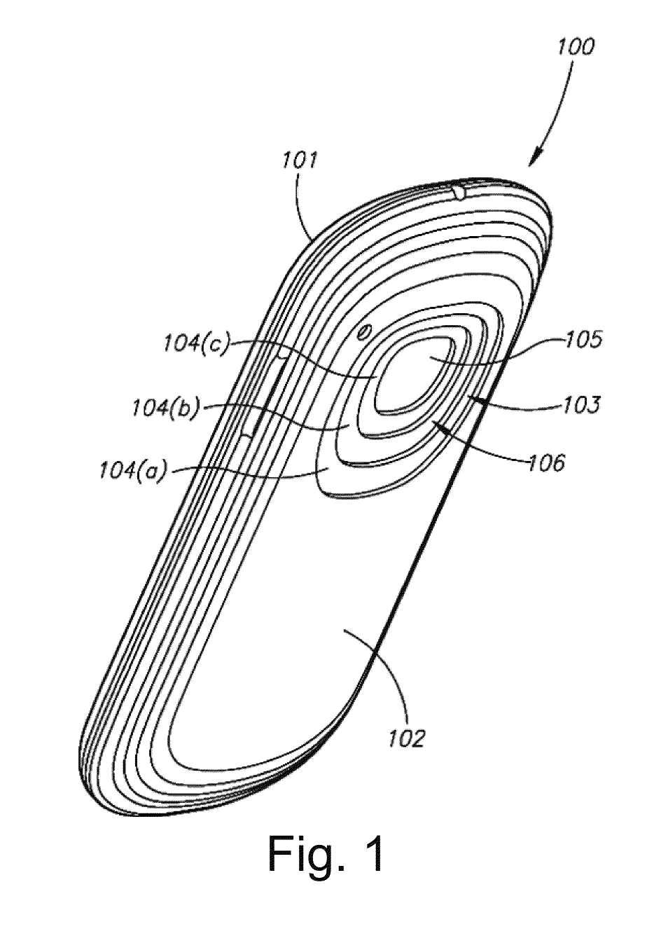

FIG. 1 shows a handheld device 100 featuring a front surface 101 (not visible in FIG. 1) and an alternate surface (in this case a back or rear surface) 102. Handheld device 100 may be held in one hand by a user, with front surface 101 facing and visible to the user. Alternate surface 102 is, in this embodiment, opposite front surface 101, and faces away from the user during typical handheld operation. In some embodiments, front surface 101 may have a display and/or other user interface elements.

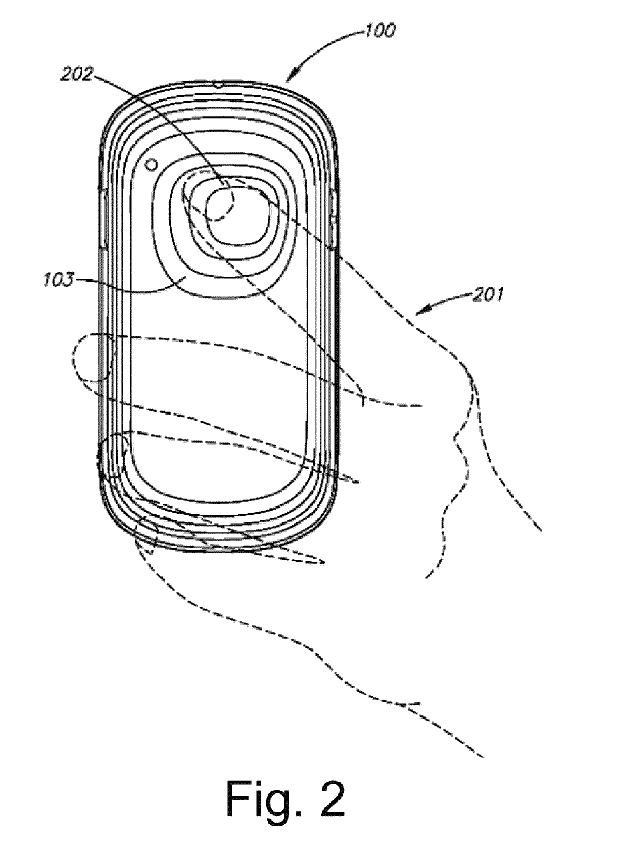

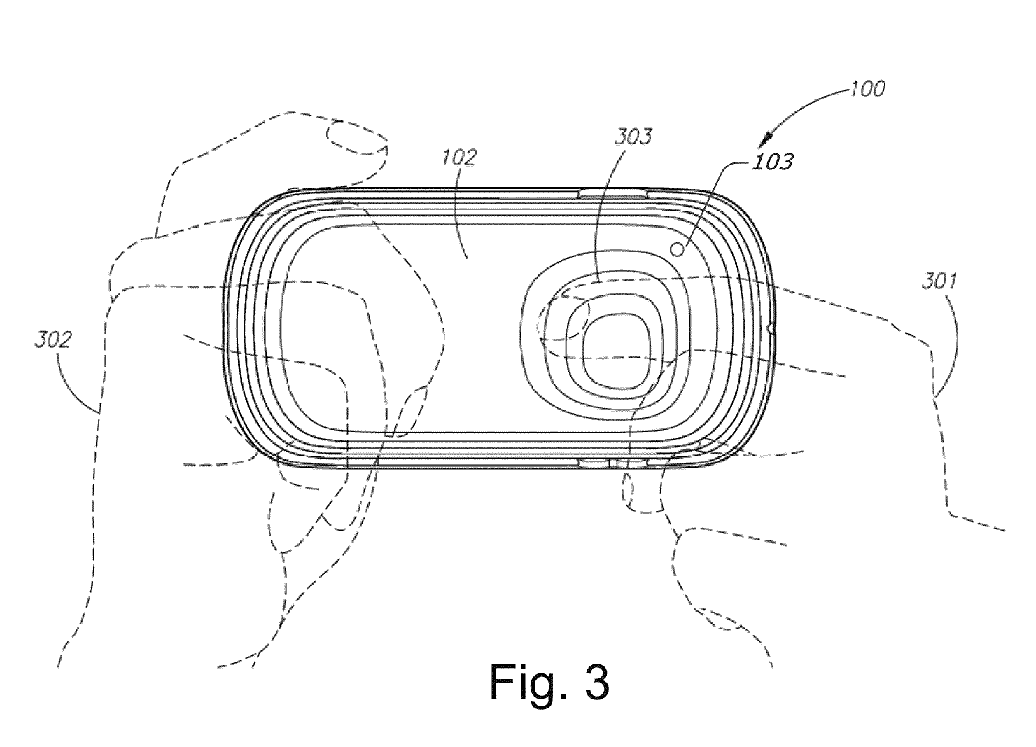

Handheld device 100 has a touch sensitive sensor 103, also referred to herein as a touch panel. Touch panel 103 is situated in the alternate surface, in this embodiment facing away from a user who is holding handheld device 100. In operation, a user's finger, such as the user's index finger, may be positioned over or on touch panel 103; touch panel 103 is positioned in such a way as to make this finger placement comfortable and convenient. FIGS. 2 and 3 show two examples of how device 100 might be grasped by a user. In FIG. 2, the user holds device 100 with a single hand 201 in a portrait orientation, with index finger 202 positioned over touch panel 103 for operation of touch panel 103. In FIG. 3, the user holds device 100 in a landscape position with left hand 301 and right hand 302, with index finger 303 of the left hand positioned over touch panel 103.

Touch panel 103 has multiple areas that are tactually delineated from each other so that a user can distinguish between the areas by touch. In the described embodiment, the areas comprise a plurality of successively nested or hierarchically arranged annular rings or bands 104. In the illustrated example, there are three such bands: an outer band 104(a), a middle band 104(b), and an inner band 104(c). Bands 104 may be concentric in some embodiments, and may surround a common central touch area 105. Individual bands 104 may be referred to as touch bands in the following discussion.

In the described embodiment, each of bands 104 has a different elevation or depth relative to alternate surface 102 of handheld device 100. There are steps or discontinuous edges between the different elevations that provide tactile differentiation between areas or bands 104, allowing a user to reliably locate a particular touch band, via tactile feedback with a finger, without visually looking at touch panel 103.

In this example, each successively inward band is stepped down in elevation from alternate surface 102 or from its outwardly neighboring band. In particular, outer band 104(a) is stepped down from alternate surface 102 and therefore is deeper or has a lower elevation than alternate surface 102. Middle band 104(b) is stepped down from its outwardly neighboring band 104(a) and is therefore deeper and has a lower elevation than outer band 104(a) Inner band 104(c) is stepped down from its outwardly neighboring band 104(b) and is therefore deeper and has a lower elevation than middle band 104(b). Similarly, central area 105 is stepped down from surrounding inner band 104(c) and is therefore deeper and has a lower elevation than inner band 104(c). Those of skill in the art will understand that touch bands 104 may each successively extend upward from the bordering larger band. Thus, outer band 104(a) may be lower than middle band 104(b), which in turn is lower than inner band 104(c), which is in turn lower than central area 105, thus forming a convex arrangement. In another embodiment, the respective bands may all share the same level, but may be tactually detectable by virtue of a raised border between them. For purposes of simplicity, however, the disclosed embodiment will address only a concave arrangement of touch pad 103.

The progressively and inwardly increasing depths of bands 104 and central area 105 relative to alternate surface 102 create a concavity or depression 106 relative to alternate surface 102. Position and dimensions of touch panel 103 can be chosen so that a user's index finger naturally locates and rests within concavity 106, such that it is comfortable to move the finger to different locations around touch panel 103.

Bands 104 can be irregularly shaped or can form a wide variety of shapes such as circles, ovals, rectangles, or squares. In the illustrated embodiment, bands 104 are irregularly shaped to allow easy finger positioning at desired locations. The irregular shape of bands 104 allows a user to learn the orientation of the bands and thus aids in non-visual interaction with touch panel 103.

Touch panel 103 is sensitive to touch, and can detect the particular location at which it is touched or pressed. Thus, it can detect which individual band 104 is touched, and the position or coordinates along the band of the touched location. A user can slide his or her finger radially between bands 104 or around a single band 104, and touch panel 103 can detect the movement and absolute placement of the finger as it moves along or over the bands. Central area 105 is also sensitive to touch in the same manner.

Touch panel 103 can be implemented using capacitive, resistive, or pressure sensing technology, or using other technologies that can detect a user's finger placement. Touch panel 103 may also integrate additional sensors, such as sensors that detect the pressing or depression of central area 105 or other areas of touch panel 103.

Different embodiment may utilize different numbers of bands, and a single band or two bands may be used in different embodiments. Furthermore, the bands may be shaped and positioned differently.

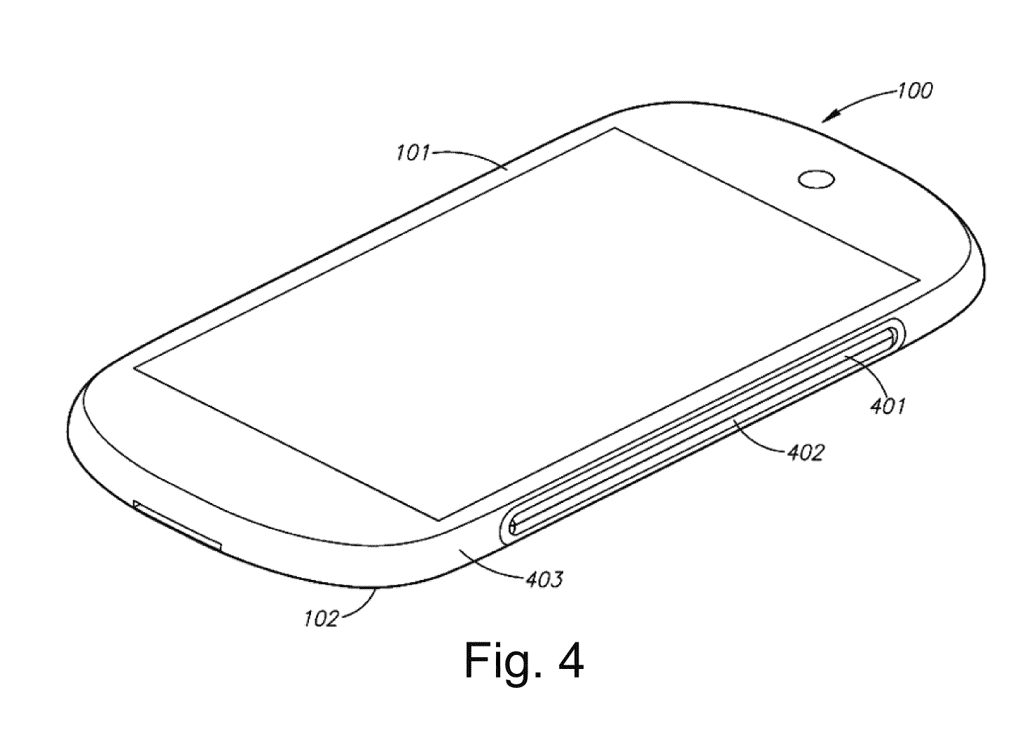

As an example of a different touch area configuration, FIG. 4 shows an embodiment of handheld device 100 having two straight or linear touch-sensitive areas or bands 401 and 402, positioned adjacently along the vertical length of the right side or edge 403 of handheld device 100. Front touch band 401 is positioned on the right edge 403, toward or adjacent front surface 101. Rear touch band 402 is positioned on the right edge 403, toward or adjacent rear surface 102.

Tactile delineation between touch bands 401 and 402 can be provided by a ridge or valley between the bands. Alternatively, the bands can have different elevations relative to right side surface 403.

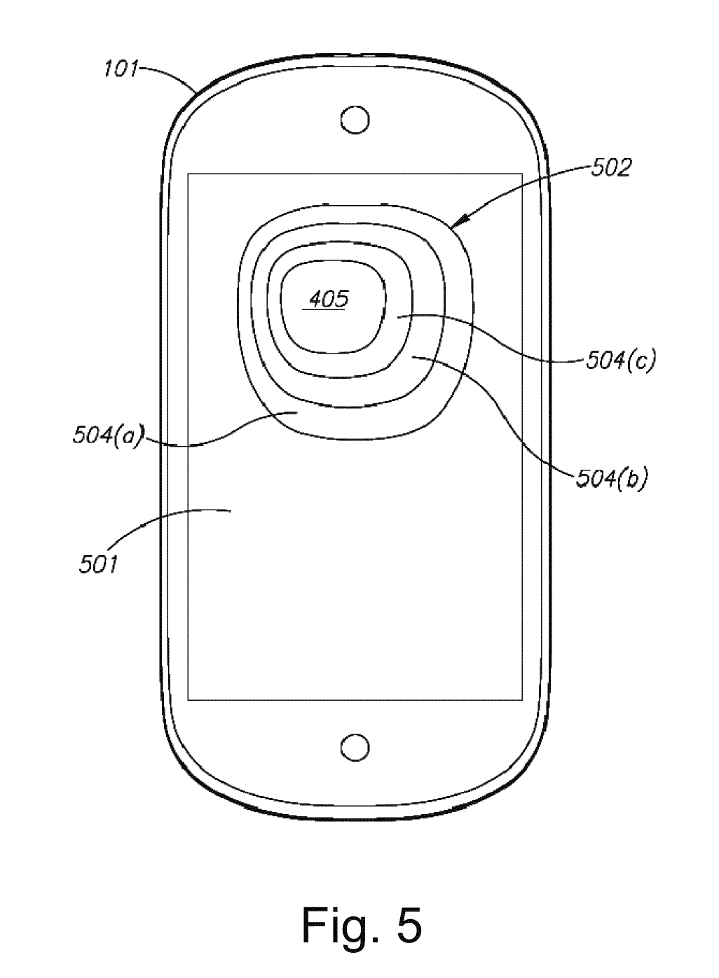

FIG. 5 is a front view of handheld device 100 (in this embodiment, a cellular phone), showing one possible configuration of front surface 101. In this embodiment, there is a front-facing display or display panel 501 in front surface 101. In some embodiments, display panel 501 may be a touch sensitive display panel. Other user interface elements, such as buttons, indicators, speakers, microphones, etc., may also be located on or around front surface 101, although they are not shown in FIG. 5.

Display panel 501 can be used as part of a user interface to operate handheld device 100. It can also be used to display content, such as text, video, pictures, etc.

A graphical menu 502 can be displayed at times on front display 501. Menu 502 has a plurality of graphically- or visually-delineated menu areas or bands 504 corresponding respectively to the tactually-delineated touch sensitive areas 104 on alternate surface 102. In this example, menu areas 504 include an outer band 504(a), a middle band 504(b), and an inner band 504(c). In addition, menu 502 includes a center visual area 505.

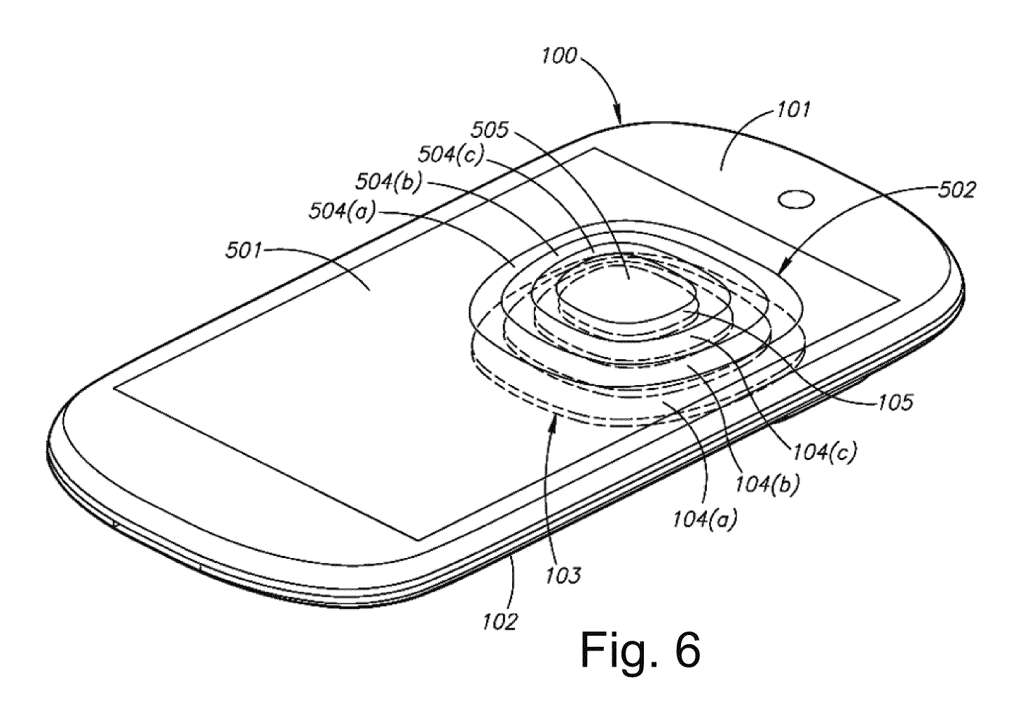

FIG. 6 illustrates relative positions of touch panel 103 and graphical menu 502 in one embodiment. In this embodiment, rear touch panel 103 is positioned opposite and directly behind display panel 501. Bands 504 of graphical menu 502 are shaped and sized the same as their corresponding touch-panel bands 104, and are positioned at the corresponding or same lateral coordinates along front surface 101 and alternate surface 102. Thus, outer touch band 104(a) has generally the same size, shape, and lateral position as outer menu band 504(a); middle touch band 104(b) has generally the same size, shape, and lateral position as middle menu band 504(b); inner touch band 104(c) has generally the same size, shape, and lateral position as outer menu band 504(c); and center area 105 of touch panel 103 has generally the same size, shape, and lateral position as center area 505 of front display panel 501.

Generally, graphical menu 502 faces the user, and touch panel 103 faces away from the user. However, display panel 501 and touch panel 103 may or may not be precisely parallel with each other. Although in particular embodiments it may be desirable to position graphical menu 502 so that is directly in front of and aligned with touch panel 103 as illustrated, other arrangements may work well in certain situations. In particular, in some embodiments there may be a lateral and/or angular offset between graphical menu 502 and touch panel 103, such that touch panel 103 is not directly behind menu 502 or is not parallel with the surface of display panel 501. Furthermore, the correspondence in size and shape between the menu bands and the touch bands may not be exact in all embodiments. Thus, the bands and center area of touch panel 103 and menu 502 may differ from one another, but will be similar enough that when a user interacts with touch panel 103, the user perceives it to have a one-to-one positional correspondence with the elements of menu 502.

In operation, as will be described in more detail below, menu items are displayed in menu bands 504. Each displayed menu item is located at a particular point on a menu band 504, and therefore corresponds to a similar point on corresponding touch band 104 of touch panel 103. A particular menu band 504 can be selected or activated by touching its corresponding touch band. A particular menu item can be selected or activated by touching the corresponding position or location on the corresponding touch band 104.

Generally, touching any particular location on touch pad 103 can be considered similar to touching or clicking on the corresponding location on graphical menu 502. If a user desires to select a menu item or some other graphical object positioned at a particular point on menu 502, for example, he or she presses the corresponding point or location on touch panel 103. The tactual delineations between bands of touch panel 103 help the user identify and move between graphical menu bands to locate particular menu item groups.

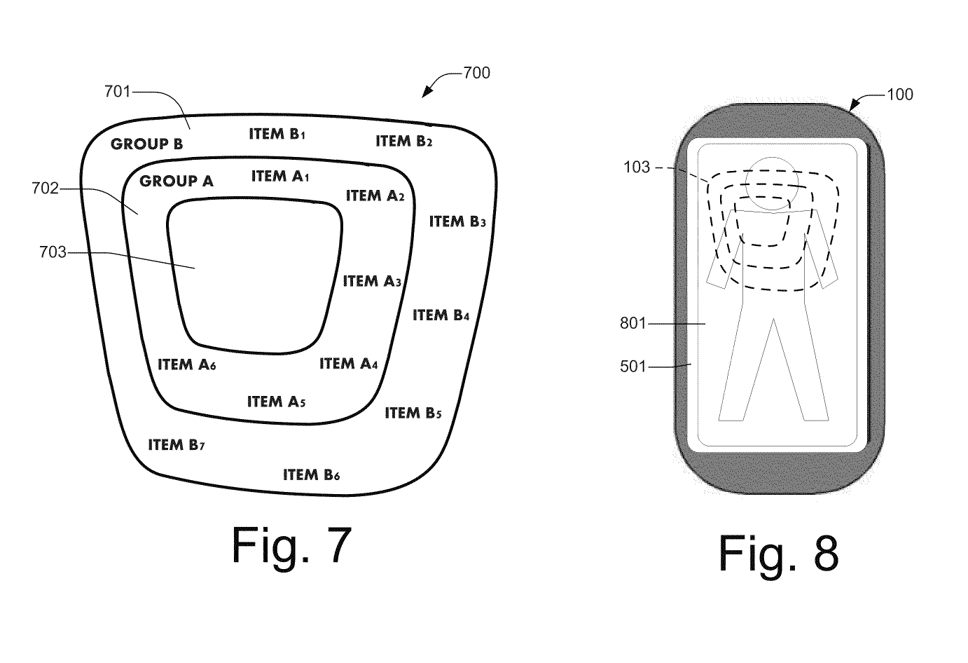

FIG. 7 shows details of how such a menu 502 might be structured. FIG. 7 shows a menu structure 700 as an example of both menu 502 and its corresponding touch panel 103. This example uses two selection bands: an outer band 701 and an inner band 702, both of which surround a center area 703. Outer band 701 corresponds to an outer displayed menu band and a correspondingly positioned outer touch band on alternate surface 102 Inner band 702 corresponds to a displayed inner menu band and a correspondingly positioned inner touch band on alternate surface 102. Center area 703 corresponds to an area within the displayed menu as well as a correspondingly positioned touch sensitive area on touch panel 103. Thus, it is assumed in this example that touch panel 103 has two touch bands, corresponding to the two touch bands shown in FIG. 7.

Generally, each of the menu bands 701 and 702 contains a group of related menu items. Each menu item may be represented by text or a graphical element, object, or icon. In this example, the items are represented by text. Inner menu band 702 contains menu items labeled “ITEM A1”, “ITEM A2”, “ITEM A3”, “ITEM A4”, “ITEM A5” and “ITEM A6”. Outer menu band 701 contains menu items labeled “ITEM B1”, “ITEM B2”, “ITEM B3”, “ITEM B4”, “ITEM B5”, “ITEM B6”, and “ITEM B7”.

Each menu band 701 and 702 may also have a band heading or title, indicating the category or type of menu items contained within the band. In this example, inner menu band 702 has a heading “GROUP A”, and outer menu band 701 has a heading “GROUP B”.

Generally, individual menu items correspond to actions, and selecting a menu item initiates the corresponding action. Thus, hand-held device 100 is configured to initiate actions associated respectively with the menu items in response to their selection.

FIG. 7 illustrates one of many variations of band shapes that might be utilized when implementing both menu 502 and its corresponding touch panel 103. In this non-symmetrical variation, the bands have larger widths toward their right-hand and lower sides. This configuration is intended to work well when the device is held in the left hand of a user, who uses his or her left index finger to interact with touch panel 103. This leaves the right hand free to interact with display panel 501 on front surface 101.

In a configuration such as this, touch panel 103 may be symmetrical, with bands that are the same width on their left and right sides. Menu 502 might be non-symmetrical, similar to menu structure 700. The non-symmetry of menu 502 might allow menu items labels and icons to easily fit within its right-hand side. However, the slight differences between the shapes of the touch bands and the corresponding menu bands will likely be nearly imperceptible to a user, or at least easily ignored. This arrangement allows menu 502 to be displayed using either a right-hand or left-hand orientation, depending on preferences of a user, while using the same touch panel 103.

User interaction can be implemented in different ways. For purposes of discussion, interaction with touch panel 103 will be described with reference to bands and locations of menu structure 700. Thus, “touching” or “tapping” ITEM A1 is understood to mean that the user touches the corresponding location on touch panel 103.

Menu structure 700 can be sensitive to the context that is otherwise presented by handheld device 100. In other words, the particular menu items found on menu 700 may vary depending on the activity that is being performed on handheld device 100. Furthermore, different bands of menu 700 can have menu items that vary depending on a previous selection within a different band. Specific examples will be described below.

In certain embodiments, menu 700 may be activated or initiated by touching center touch area 105 of touch panel 103. In response, handheld device displays menu 700. Alternatively, menu 700 might be activated by touching any portion of touch panel 103, or by some other means such as by interaction with front-surface elements of handheld device 100.

Upon initially displaying menu structure 700, individual menu items may or may not be displayed. For example, upon initial display, each menu band may only indicate its group heading or title, and the individual menu items may be hidden.

After activating menu structure 700 by touching center area 703, the user may touch one of the touch bands to activate or reveal the menu items within that touch band. For example, the user may touch inner band 702, which causes device 100 to activate that band and to display or reveal its individual menu items. In addition, activating a particular band might result in that band being highlighted in some manner, such as by an animation, bold text, or distinguishing shades or colors. Activation or selection of a band might also be indicated by enlarging that band on displayed menu 700 in relation to other, non-activated bands.

Another band might be activated by touching it, or by selecting an item from a first band. For example, outer band 701 may contain items that depend on a previous selection made from the items of inner band 702. Thus, touching or selecting an item within inner band 702 may activate outer band 701, and outer band 701 might in this scenario contain items or commands related to the menu item selected from inner band 702.

Selection of a band or menu item may be made by touching and releasing the corresponding location on touch panel 103. Alternatively, selection may be made by touching at one location, sliding to another location, and releasing. For example, menu structure 700 may be implemented such that touching center area 703 opens menu structure 700, and sliding to inner band 702 allows the user to move to a menu item on inner band 702. Releasing when over a particular menu item might select or activate that menu item.

Selection within menu structure 700 or within a band of menu structure 700 may be accompanied by a highlight indicating the location of the user's finger at any time within the menu structure. For example, touching in a location on touch panel 103 in a location corresponding to ITEM A1 may cause ITEM A1 to become bold or otherwise highlighted. Furthermore, any area that is currently being touched can be made to glow on display panel 501, or some similar visual mechanism can be used to indicate finger placement and movement on menu structure 700. Thus, a user might touch a menu band, move his or her finger along the menu band until the desired menu item is highlighted, and then release his or her touch, thereby activating the menu item that was highlighted upon the touch release.

### Usage Scenarios

The user interface arrangement described above can be used in a variety of ways. The following examples assume the use of front-facing display panel 501 and rear-facing touch panel 103. For purposes of example and illustration, touch panel 103 will not be explicitly shown in the figures accompanying this discussion. It is assumed that in the examples described, touch panel 103 lies directly behind the illustrated graphical menus, and that the touch bands of the touch panel have shapes and sizes that correspond at least roughly with the menu bands of the displayed graphical menus. User interactions with the touch panel will be described with reference to corresponding points on the displayed graphical menus.

FIGS. 8-11 illustrate how the elements and techniques described above might be used to edit and share a picture that is stored on a handheld device such as a cellular telecommunications device. In FIG. 8, handheld device 100 is displaying a photograph 801 on its display surface 501. Touch panel 103 is represented in dashed lines to indicate its location relative to display panel 501. A menu is not displayed in FIG. 8.

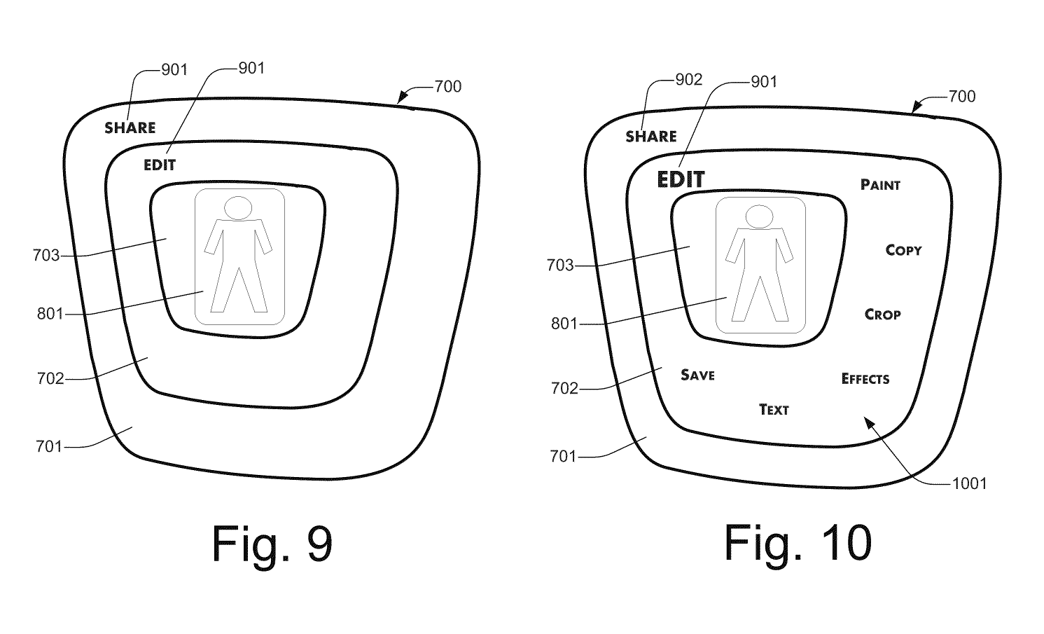

FIG. 9 shows a menu 901 that is displayed on display panel 501 in response to a user touching center area 105 of touch panel 103. This menu is configured to allow a user to perform various operations with respect to the displayed picture 801. The object of these operations, picture 801, is displayed or represented within center area 703. Inner band 702 is configured to correspond to various editing operations that can be performed on picture 801, and has a band heading 901 that reads “EDIT”. Outer band 701 is configured to correspond to various communications options that can be performed in conjunction with picture 801, and has a band heading 902 that reads “SHARE”. A user can touch anywhere in inner band 702 to activate or reveal the menu items of that band. A user can touch anywhere in outer band 701 to activate or reveal the menu items of that band.

FIG. 10 shows the result of a user touching inner band 702. In response to touching a band, it is activated or highlighted. In this example, an activated band is enlarged and its menu items are revealed. Menu items 1001 of inner band 702 comprise “Paint”, “Copy”, “Crop”, “Effects”, “Text”, and “Save”. While still touching inner band 702, the user can move his or her finger around inner band 702 until it is positioned corresponding to a desired menu item. In some embodiments, the location at which the user is touching the band will be highlighted or somehow indicated on display 501 so that finger movement can be visually confirmed. When the finger is at the desired menu item, the user released the finger touch and the menu item is selected or activated.

Suppose, for example, that the user wants to crop the displayed picture 801. The user first touches and releases center area 703 to activate menu 700. The user then touches inner band 702, which reveals menu items 901 relating to editing actions. The user moves his or her finger until touching the menu item “Crop”, and releases. This causes device 100 to display an on-screen tool for cropping picture 801. Although this tool is not illustrated, picture 801 may be again displayed in full size on front display panel 501, as in FIG. 8, and a moveable rectangle may be shown for the user to position in the desired cropping location. The user may drag the displayed rectangle by pressing and dragging on display panel 501 to achieve the desired positioning of the rectangle, and the desired cropping of picture 801.

FIG. 11 shows a subsequent operation that may be performed on the cropped picture 801. After the cropping operation described above, the cropped picture 801 is displayed in center area 703 as the object of a proposed action. Menu 700 may reappear after the cropping operation, or may be reactivated by the user again touching center area 703.

In the example of FIG. 11, the user has touched the outer band 701 to reveal the menu items 1101 of that band, which relate to different communications options that are available with regard to the targeted picture. These options include “Email”, “Text”, “IM”, “Facebook”, “Twitter”, and “Blog”. These menu items correspond to actions that device 100 or an application program within device 100 will initiate upon selection of the menu items. Notice that in this example, as with FIG. 10, the activated menu band is enlarged to indicate that it is active. Enlarging the active menu band also allows its menu items to occupy more screen space and therefore make them more visible to the user.

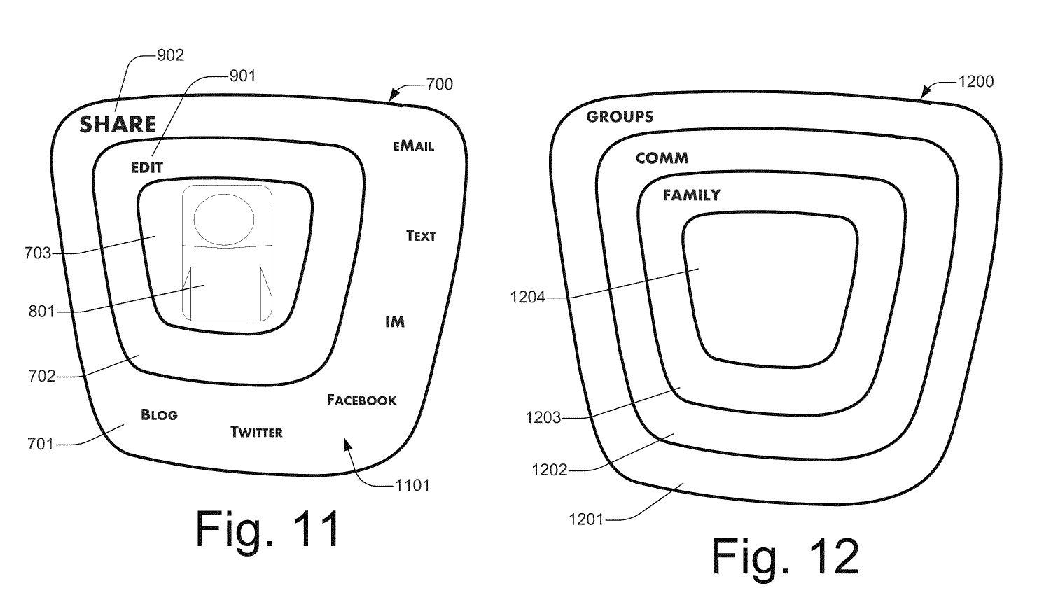

FIGS. 12-15 illustrate how the elements and techniques described might be used to select and interact with different contacts, using a menu structure 1200 that is displayed on handheld device 100. Example menu 1200 uses three levels of menu bands and corresponding touch bands: an outer band 1201, a middle band 1202, and an inner band 1203. These bands surround a center area 1204.

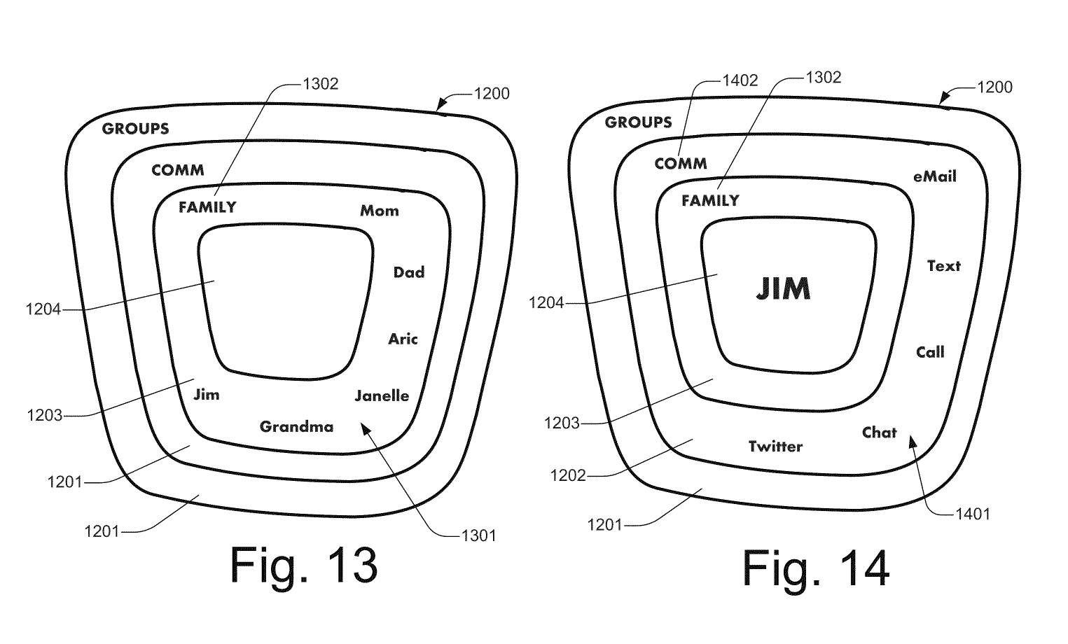

FIG. 13 shows the menu items 1301 revealed upon activating inner band 1203. In this example, inner band 1203 contains menu items corresponding to contacts that the user has designated as belonging to a particular group. It contains a group heading or label 1302, which in this example reads “FAMILY”, indicating that the contacts within this band are part of the “FAMILY” contact group. In this example, the menu items include “Mom”, “Dad”, “Aric”, “Janelle”, “Grandma”, and “Jim”. A user can touch or select any one of these menu items to select the corresponding contact.

FIG. 14 shows menu items 1401 that are revealed upon activating middle band 1202. These menu items relate to activities that can be performed with respect to a contact that has been selected from inner band 1203. Middle band 1202 has a group heading or label 1402, which in this example reads “COMM”, indicating that the band contains communications options.

In this example, “Jim” has been previously selected from inner band 1203 and is displayed in center area 1204 as the object of any selected operations. The menu items and corresponding operations include “eMail”, “Text”, “Call”, “Chat”, and “Twitter”. The available menu items might vary depending on the information available for the selected contact. For example, some contacts might only include a telephone number, and communications options might therefore be limited to texting and calling. Other contacts might include other information such as Chat IDs, and a “Chat” activity might therefore be available for these contacts. Thus, the menu items available in this band are sensitive to the menu context selected in previous interactions with menu 1200.

FIG. 15 shows menu items 1501 that are revealed upon activating outer band 1201. Outer band 1201 contains menu items corresponding to different contact groups that a user has defined, and contains a group heading or title 1502 that reads “GROUPS”. In this example, these contact groups include “Family”, “Office”, “Friends”, and “Favorites”. Selecting one of these groups changes the context of menu 1200. In particular, it changes the contact group that is shown within inner band 1203. After selecting “Office” from outer band 1201, for example, the label 1302 of inner band 1203 will change to “OFFICE”, and the listed menu items 1301 within inner band 1203 will change to those that the user has included in the “User” group.

The above usage scenarios are only examples, and the user described interaction techniques might be useful in many different situations. As another example, the described menu structure might be used as an application launcher, with different types of applications being organized within different menu bands. End-users may be given the ability to organize applications within menu bands in accordance with personal preferences.

The described menu structure might also be used as a general context menu, presenting operations such as copy, paste, delete, add bookmark, refresh, etc., depending on operations that might be appropriate at a particular time when the menu structure is opened. Again, different types of operations might be presented in different menu bands, such as “edit” operations in an inner band and “sharing” operations in an outward band.

Furthermore, support for the menu structure can be provided through an application programming interface (API) and corresponding software development kit (SDK) to allow the menu functionality to be used and customized by various application programs. In addition, the operating system of the handheld device can expose APIs allowing application programs to register certain activities and actions that might be performed with respect to certain types of objects, or in certain contexts. Registering in this manner would result in the indicated activities or actions being included in the contextual menus described above.

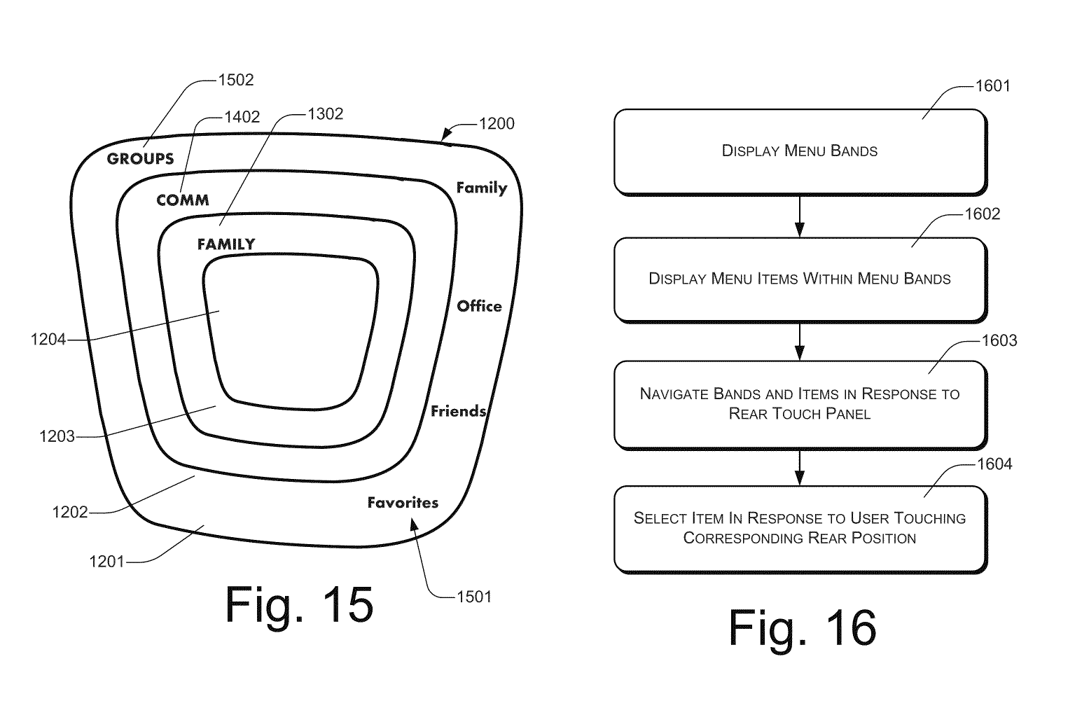

FIG. 16 illustrates the above user interface techniques in simplified flowchart form. An action 1601 comprises displaying a menu on a front-facing display of a handheld device. As described above, the menu may have visually-delineated menu areas or bands corresponding in shape and position to the nested or hierarchical touch bands of a rear-facing touch sensor of the handheld device.

An action 1602 comprises displaying menu items in the menu bands. As already described, each menu item corresponds to a position on the rear-facing touch sensor of the handheld device.

An action 1603 comprises navigating among the menu bands and menu items in response to rear touch sensor input. Action 1604 comprises selecting a particular one of the menu items in response to the user touching its corresponding position on the rear-facing touch sensor.

Note that in the embodiments described above, having a front-facing touch-sensitive display, some of the user interactions might be performed by touching the display itself at the desired menu location, as an alternative to touching the corresponding location on the rear touch panel. Some embodiments may allow the user to touch either the front displayed menu or the corresponding rear touch panel, at the user's discretion.

### Device Components

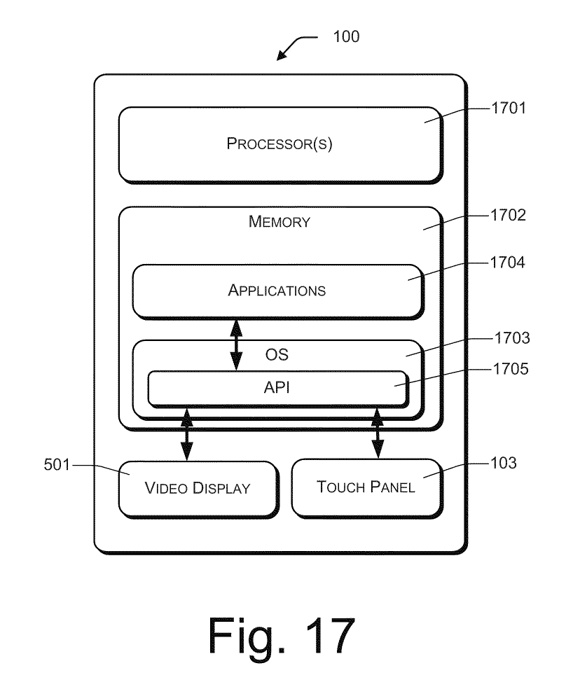

FIG. 17 shows an exemplary handheld or mobile device 100 and the components of mobile device 100 that are most relevant to the foregoing discussion.

The handheld device 100 of FIG. 17 comprises one or more processors 1701 and memory 1702. Memory 1702 is accessible and readable by processors 1701 and can store programs and logic for implementing the functionality described above. Specifically, memory 1702 can contain instructions that are executable by processors 1701 to perform and implement the functionality described above.

In many cases, the programs and logic of memory 1702 will be organized as an operating system (OS) 1703 and applications 1704. OS 1703 contains logic for basic device operation, while applications 1704 work in conjunction with OS 1703 to implement additional, higher-level functionality. Applications 1704 may in many embodiments be installed by device manufacturers, resellers, retailers, or end-users. In other embodiments, the OS and applications may be built into the device at manufacture.

Note that memory 1702 may include internal device memory as well as other memory that may be removable or installable. Internal memory may include different types of machine-readable media, such as electronic memory, flash memory, and/or magnetic memory, and may include both volatile and non-volatile memory. External memory may similarly be of different machine-readable types, including rotatable magnetic media, flash storage media, so-called “memory sticks,” external hard drives, network-accessible storage, etc. Both applications and operating systems may be distributed on such external memory and installed from there. Applications and operating systems may also be installed and/or updated from remote sources that are accessed using wireless means, such as WiFi, cellular telecommunications technology, and so forth.

Handheld device 100 also has a front-facing display 501 and a rear-facing touch panel 103, the characteristics of which are described above. OS 1703 interacts with front display 501 and rear touch panel 103 to implement the user interface behaviors and techniques described above. In many embodiments, handheld device 100 might have an application programming interface (API) 1705 that exposes the functionality of front display 501 and rear touch panel 103 to applications through high-level function calls, allowing third-party application to utilize the described functionality without the need for interacting with device components at a low level. API 1705 may include function calls for performing the actions described with reference to FIG. 16, including:
displaying a menu on a front-facing display, the menu having visually-delineated menu bands corresponding in shape and position to the nested touch bands of the rear-facing touch sensor;
displaying menu items in the menu bands, each menu item corresponding to a position on the rear-facing touch sensor; and
selecting a particular one of the menu items in response to the user touching its corresponding position on the rear-facing touch sensor.

Similarly, API 1705 may allow application programs to register certain functions or actions, along with potential objects of those functions or actions, allowing the handheld device to include those functions and activities as menu items in appropriate contexts.

Note that various embodiments include programs, devices, and components that are configured or programmed to perform in accordance with the descriptions above, as well as computer-readable storage media containing programs or instructions for implementing the described functionality.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims

Further, it should be noted that the system configurations illustrated above are purely exemplary of systems in which the implementations may be provided, and the implementations are not limited to the particular hardware configurations illustrated. In the description, numerous details are set forth for purposes of explanation in order to provide a thorough understanding of the disclosure. However, it will be apparent to one skilled in the art that not all of these specific details are required.

We claim:

1. A handheld device, comprising:
a front-facing display;
a rear-facing touch sensor;
the rear-facing touch sensor having a plurality of successively nested touch bands surrounding a central area;
the touch bands being tactually delineated from each other; and
the rear-facing touch sensor being positioned for operation by a user's finger when the user holds the handheld device.

2. A handheld device as recited in claim 1, wherein each successively inward touch band is stepped down in elevation to form a concavity in the rear of the handheld device.

3. A handheld device as recited in claim 1, further comprising:
one or more application programming interfaces that are useable by application programs to implement user interfaces in conjunction with the front-facing display and the rear-facing touch sensor;
the one or more application programming interfaces being configured to perform actions comprising:
displaying a menu on a front-facing display, the menu having visually-delineated menu bands corresponding in shape and position to the nested touch bands of the rear-facing touch sensor;
displaying menu items in the menu bands, each menu item corresponding to a position on the rear-facing touch sensor; and
selecting a particular one of the menu items in response to the user touching its corresponding position on the rear-facing touch sensor.

4. A handheld device as recited in claim 1, the handheld device having one or more processors configured to perform actions comprising:
displaying a menu on a front-facing display, the menu having visually-delineated menu bands corresponding in shape and position to the nested touch bands of the rear-facing touch sensor;
displaying menu items in the menu bands, each menu item corresponding to a position on the rear-facing touch sensor; and
selecting a particular one of the menu items in response to the user touching its corresponding position on the rear-facing touch sensor.

5. A handheld device, comprising:
a front display panel;
one or more tactually-delineated touch sensitive areas opposite the front display panel;
a menu displayed at times on the front display panel, the menu having one or more visually-delineated menu areas corresponding respectively to the one or more tactually-delineated touch sensitive areas;
a plurality of menu items arranged respectively at corresponding points in the menu areas and the tactually-delineated touch sensitive areas; and
the menu items being selectable by touching their corresponding points in the tactually-delineated touch sensitive areas.

6. A handheld device as recited in claim 5, wherein the touch-sensitive areas are adjacent each other.

7. A handheld device as recited in claim 5, wherein the touch-sensitive areas are concentric.

8. A handheld device as recited in claim 5, wherein the touch-sensitive areas are linear.

9. A handheld device as recited in claim 5, further comprising one or more application programming interfaces that can be called by application programs to register menu items for inclusion in the menu areas.

10. A handheld device as recited in claim 5, wherein the handheld device is configured to initiate actions associated respectively with the menu items in response to their selection.

11. A handheld device as recited in claim 5, wherein each menu area has a related group of the menu items.

12. A handheld device as recited in claim 5, wherein touching a particular tactually-delineated touch sensitive area reveals the menu items of the corresponding menu area.

13. A handheld device as recited in claim 5, wherein the menu items vary depending on the context presented by the handheld device.

14. A handheld device as recited in claim 5, wherein each menu area is displayed directly opposite its corresponding tactually-delineated touch sensitive area.

15. A handheld device as recited in claim 5, wherein:
the touch sensitive areas comprise an outward band and one or more successively inward bands; and
the bands have successively and inwardly deeper elevations to delineate them from each other, the bands forming a concavity in the rear of the handheld device.

16. A handheld device as recited in claim 5, wherein:
the touch sensitive areas comprise an outward band and one or more successively inward bands; and
the bands have different elevations to delineate them from each other.

17. A handheld device as recited in claim 5, wherein the touch sensitive areas are delineated by having different elevations relative to the rear of the handheld device.

18. A handheld device as recited in claim 5, wherein the touch sensitive areas comprise one or more nested bands and a central area.

19. A method of interacting with a user of a handheld device, comprising:
displaying a menu on a front display of the handheld device, the menu having visually-delineated menu bands, each of the menu bands corresponding in shape and position to a corresponding tactually-delineated rear touch band of the handheld device;
displaying menu items in the menu bands in response to the user touching one or more of the rear touch bands, each menu item corresponding to a position on one of the rear touch bands; and
selecting a particular one of the menu items in response to the user touching its corresponding position on one of the rear touch bands.

20. A method as recited in claim 19, further comprising varying the menu items in response to the context presented by the handheld device.

21. A method as recited in claim 19, wherein each menu band has a related group of the menu items.

22. A method as recited in claim 19, further comprising initiating actions associated respectively with the menu items in response to touching their corresponding positions on the rear touch bands.

23. A method as recited in claim 19, wherein the menu bands surround a central visual area.

24. A method as recited in claim 19, wherein each menu band is displayed directly opposite its corresponding rear touch band.

25. A method as recited in claim 19, further comprising exposing one or more application programming interfaces that can be called by application programs to register menu items for inclusion in the menu bands.

26. One or more computer-readable storage media containing instructions that are executable by a handheld device to perform actions comprising:
displaying a plurality of visually-delineated menu areas, the menu areas corresponding in shape to a plurality of tactually-delineated touch areas on the handheld device;
in response to a user touching one of the touch areas, displaying menu items in at least one of the menu area; and
selecting a particular one of the displayed menu items in response to the user touching a corresponding position on one of the touch areas.

27. One or more computer-readable storage media as recited in claim 26, wherein the visually-delineated menu areas correspond in shape to tactually-delineated touch areas on the back of the handheld device.

28. One or more computer-readable storage media as recited in claim 26, wherein the visually-delineated menu areas correspond in shape to tactually-delineated touch areas on an edge of the handheld device.

29. One or more computer-readable storage media as recited in claim 26, wherein each menu area has a related group of the menu items.

30. One or more computer-readable storage media as recited in claim 26, wherein touching a particular touch sensitive area reveals the menu items of the corresponding menu area.

31. One or more computer-readable storage media as recited in claim 26, wherein the menu items vary depending on context.

32. One or more computer-readable storage media as recited in claim 26, the actions further comprising exposing one or more application programming interfaces that can be called by application programs to register menu items for inclusion in the menu areas.

33. One or more computer-readable storage media as recited in claim 26, wherein each menu area is positioned directly opposite a corresponding touch sensitive area.
